(19) United States
(12) Patent Application Publication
(10) Pub. No.: US 2023/0313339 A1
(43) Pub. Date: Oct. 5, 2023

(54) METHOD FOR TREATING RETAINED PLUTONIUM IN WASTE ORGANIC PHASE OF PLUTONIUM URANIUM REDUCTION EXTRACTION (PUREX) PROCESS

(71) Applicant: China Institute of Atomic Energy, Beijing (CN)

(72) Inventors: Qian LIU, Beijing (CN); Liyang ZHU, Beijing (CN); Xuan HAO, Beijing (CN); Youshi LAN, Beijing (CN); Jin ZHOU, Beijing (CN); Suliang YANG, Beijing (CN); Guoxin TIAN, Beijing (CN); Qin CHEN, Beijing (CN); Guoguo ZHANG, Beijing (CN)

(73) Assignee: China Institute of Atomic Energy, Beijing (CN)

(21) Appl. No.: 17/947,428

(22) Filed: Sep. 19, 2022

Related U.S. Application Data
(63) Continuation of application No. PCT/CN2022/084634, filed on Mar. 31, 2022.

(30) Foreign Application Priority Data
Feb. 17, 2022 (CN) 202210147589.2

(51) Int. Cl. C22B 60/04; C01G 56/00

(52) U.S. Cl. CPC C22B 60/04; C01G 56/001

(57) ABSTRACT

A method for treating retained plutonium in a waste organic phase of a plutonium uranium reduction extraction (PUREX) process is provided. The waste organic phase of the PUREX process contains an organic solvent and plutonium, and the method includes contacting the waste organic phase of the PUREX process with an aqueous back extraction solution containing 2,6-pyridinedicarboxylic acid for back extraction to obtain a plutonium back extraction product; and the plutonium in the back extraction solution may be loaded onto the column for adsorption, transformation and desorption by an anion exchange column, ultimately recovering plutonium in the back extraction solution.

### CROSS REFERENCE TO RELATED APPLICATION

The present application is a continuation application of international application PCT/CN2022/084634 filed on Mar. 31, 2022, which claims foreign priority to Chinese Patent Application No. 202210147589.2 filed on Feb. 17, 2022, and designated the U.S., the entire contents of which are incorporated herein by reference.

### TECHNICAL FIELD

The disclosure relates to the field of radioactive waste treatment, in particular a method for treating retained plutonium in a waste organic phase of a plutonium uranium reduction extraction (PUREX) process.

### BACKGROUND

A PUREX (Plutonium Uranium Reduction Extraction) process is currently the only commercial spent fuel post-treatment process. In this process, a TBP-kerosene-HNO₃ system is subjected to chemical and radiation degradation under the action of chemistry and radiation, and degradation products of TBP are mainly dibutyl phosphate (HDBP), monobutyl phosphate (H₂MBP) and H₃PO₄, and a diluent and nitric acid are degraded to produce aldehyde, carboxylic acid, hydroxamic acid and other organic nitro compounds. HDBP and H₂MBP in the above degradation products are prone to form complexes with Pu (IV) and Zr (IV), and the complexes have binding energies greater than those of Pu (IV) and Zr (IV) with TBP, and are less prone to back extraction in a back extraction section, resulting in retention of their metal ions in an organic phase. As the production run continues, the degradation products continue to accumulate in the organic phase, and the degradation products and the metal ions form complexes which are low in solubility in the organic phase, causing difficulties in phase separation.

In order to slow down the harm of the accumulation of the degradation products to the extraction process, Na₂CO₃ is often used to wash the degradation products in the organic phase, but a problem of plutonium metal retention in a waste organic phase still cannot be solved. Thus, there is an urgent need to develop a method that can elute and recover plutonium from a waste organic phase of a spent fuel post-treatment process (especially a waste organic phase with high plutonium content that is placed for a long time).

### SUMMARY OF INVENTION

The disclosure aims to provide a method for treating retained plutonium in a waste organic phase of a plutonium uranium reduction extraction (PUREX) process, and this method is capable of efficiently eluting and recovering a high content of retained plutonium in the waste organic phase, even a waste organic phase with high retained plutonium content that is placed for a long time.

To achieve the above objective, the disclosure provides a method for treating retained plutonium in a waste organic phase of a plutonium uranium reduction extraction (PUREX) process. The waste organic phase of the PUREX process contains an organic solvent and plutonium, and the method includes contacting the waste organic phase of the PUREX process with an aqueous back extraction solution containing 2,6-pyridinedicarboxylic acid for back extraction to obtain a back extraction product.

Optionally, a weight ratio of the aqueous back extraction solution containing 2,6-pyridinedicarboxylic acid to the waste organic phase is 1:(1-10), preferably 1:(1-5).

Optionally, the content of 2,6-pyridinedicarboxylic acid in the aqueous back extraction solution is 0.1-0.7 wt%, preferably 0.3-0.5 wt%.

Optionally, the back extraction is performed at a temperature of 10-40° C., preferably 20-30° C. at an oscillation rate of 400-700 rpm, preferably 500-600 rpm for 10-30 min, preferably 15-20 min.

Optionally, the method further includes: S1, contacting the back extraction product with an anion exchange resin such that plutonium in the back extraction product is adsorbed on the anion exchange resin to obtain an anion exchange resin adsorbing plutonium; S2, contacting the anion exchange resin adsorbing plutonium with a transformation liquid to obtain a transformed anion exchange resin adsorbing plutonium; and S3, contacting the transformed anion exchange resin adsorbing plutonium with an eluent to obtain an elution product.

Optionally, the step S1 further includes contacting the back extraction product with the anion exchange resin after a pH of the back extraction product is adjusted to be 1-4.

Optionally, the transformation liquid contains 7-8 mol/L of nitric acid.

Optionally, the eluent includes 0.3-1.0 mol/L of an aqueous nitric acid solution, or the eluent is an aqueous solution containing 0.3-1.0 mol/L of nitric acid and 0.05-0.15 mol/L of NH₂OH.

Optionally, the anion exchange resin includes at least one of DOWEX resin, D201 resin and Diaion PA308 resin, preferably DOWEX 1×4 anion exchange resin.

Optionally, the method further includes contacting the waste organic phase of the PUREX process with deionized water and/or an alkaline solution for deacidification prior to contacting the waste organic phase of the PUREX process with the aqueous back extraction solution containing 2,6-pyridinedicarboxylic acid. The deacidification of the waste organic phase is not particularly limited in the disclosure, and the alkaline solution, such as a sodium hydroxide solution, may be added to the aqueous back extraction solution for deacidification according to the residual acid content in the waste organic phase.

Through the above technical solution, the disclosure provides the method for treating retained plutonium in the waste organic phase of the PUREX process, the method can efficiently elute and recover plutonium metal in a waste organic phase with high retained plutonium content, most of the plutonium metal is eluted into an aqueous phase, the plutonium content in the waste organic phase after elution may be less than 0.1 mg/L, and 99% or above of plutonium in the aqueous phase is recovered, meeting the requirements for the plutonium content in the waste organic phase in a waste treatment technology.

Other features and advantages of the disclosure will be described in detail in the following detailed description.

### BRIEF DESCRIPTION OF THE DRAWINGS

FIG. 1 is a graph of a counting rate of an eluate of an anion exchange column as a function of a volume of the eluate.

### EMBODIMENTS

The specific examples of the disclosure will be described in detail below with reference to the accompanying drawings. It should be understood that the specific examples described herein are only used to illustrate and explain the disclosure, but not to limit the disclosure.

The disclosure provides a method for treating retained plutonium in a waste organic phase of a plutonium uranium reduction extraction (PUREX) process. The waste organic phase of the PUREX process contains an organic solvent and plutonium, and the method includes contacting the waste organic phase of the PUREX process with an aqueous back extraction solution containing 2,6-pyridinedicarboxylic acid for back extraction to obtain a back extraction product.

In accordance with the method of the disclosure, plutonium is able to migrate from the waste organic phase of the PUREX process into an aqueous phase containing 2,6-pyridinedicarboxylic acid, i.e., the back extraction product during the back extraction process.

A weight ratio of the aqueous back extraction solution containing 2,6-pyridinedicarboxylic acid to the waste organic phase can vary in a large range; in one preferred example, the weight ratio of the aqueous back extraction solution containing 2,6-pyridinedicarboxylic acid to the waste organic phase is 1:(1-10), more preferably 1:(1-5).

The content of 2,6-pyridinedicarboxylic acid in the aqueous back extraction solution enables a dispersion coefficient of plutonium in the aqueous back extraction solution to be greater than that of plutonium in the waste organic phase of the PUREX process. In one preferred example, the content of 2,6-pyridinedicarboxylic acid in the aqueous back extraction solution is 0.1-0.7 wt%, preferably 0.3-0.5 wt%.

The conditions for back extraction in the disclosure are not particularly limited, and can be selected by those skilled in the art according to actual needs. The back extraction rate of retained plutonium in the waste organic phase obtained under the back extraction conditions in the limited range of the disclosure is higher, which can meet the requirements for the plutonium content in the waste organic phase in the waste treatment technology. For example, in one example, the back extraction is performed at a temperature of 5-40° C., preferably 20-30° C. at an oscillation rate of 400-700 rpm, preferably 500-600 rpm for 5-30 min, preferably 15-20 min.

After the back extraction, plutonium can also be extracted from the obtained back extraction product by adsorption and elution using an ion exchange resin and thus preferably the method may further include: S1, contacting the back extraction product with an anion exchange resin such that plutonium in the back extraction product is adsorbed on the anion exchange resin to obtain an anion exchange resin adsorbing plutonium; S2, contacting the anion exchange resin adsorbing plutonium with a transformation liquid to obtain a transformed anion exchange resin adsorbing plutonium; and S3, contacting the transformed anion exchange resin adsorbing plutonium with an eluent to obtain an elution product. The elution product contains extracted plutonium.

In order to enable better plutonium adsorption by the anion exchange resin, preferably, the step S1 further includes contacting the back extraction product with the anion exchange resin after a pH of the back extraction product is adjusted to be 1-4.

In order to achieve a better transformation effect, preferably, the transformation liquid contains 7-8 mol/L of nitric acid.

In order to achieve a better elution effect, preferably, the eluent includes 0.3-1.0 mol/L of an aqueous nitric acid solution, or the eluent is an aqueous solution containing 0.3-1.0 mol/L of nitric acid and 0.05-0.15 mol/L of NH₂OH.

In order to enable better plutonium adsorption by the anion exchange resin, preferably the anion exchange resin includes at least one of DOWEX resin, D201 resin and Diaion PA308 resin, preferably DOWEX 1×4 anion exchange resin.

In order that an acid in the waste organic phase does not affect the back extraction, preferably, the method further includes contacting the waste organic phase of the PUREX process with deionized water and/or an alkaline solution for deacidification prior to contacting the waste organic phase of the PUREX process with the aqueous back extraction solution containing 2,6-pyridinedicarboxylic acid, and the deacidified waste organic phase has a pH of 0.5-3. The deacidification of the waste organic phase is not particularly limited in the disclosure, and the alkaline solution, such as a sodium hydroxide solution, may be added to the aqueous back extraction solution for deacidification according to the residual acid content in the waste organic phase.

The disclosure is further illustrated below by way of examples, but the disclosure is not thus limited in any way.

### Example 1

A 2BW feed solution obtained from a certain thermal test in a PUREX process research of China Institute of Atomic Energy was used as a treatment subject; the feed solution was a waste organic phase with the plutonium content exceeding the standard obtained from a plutonium purification cycle, and was subjected to excessive plutonium elution by using a dilute acid solution, a tetravalent uranium solution, a N,N-dimethylhydroxylamine solution and a sodium carbonate solution, respectively in the test process. Its main chemical components were as follows: 30% by volume of tributyl phosphate (TBP) and 70% by volume of hydrogenated kerosene, with a plutonium content of 0.057 g/L, a nitric acid content of 0.03 mol/L, a dibutyl phosphate (DBP) content of 0.9 mmol/L, and a monobutyl phosphate (MBP) content of 0.23 mmol/L, and the contents of other degradation products and metal ions were not determined. Prior to this test, the feed solution had been placed for more than 5 years and its appearance was a yellow-brown clear solution.

A treatment process was as follows:

(1) 10 µL of the above waste organic phase was taken for liquid scintillation measurement and the content of ²³⁹⁺²⁴⁰Pu in the waste organic phase was calculated to be 0.057 g/L; deionized water was added to the waste organic phase, and mixed with the waste organic phase in a volume ratio of 1:1, followed by shaking at room temperature for 5 min to remove a residual acid in the waste organic phase;

(2) 20.87 mg of solid DPA (2,6-pyridinedicarboxylic acid) was weighed and added into a centrifuge tube, and 5 mL of a 0.4 mol/L nitric acid solution was then added to prepare an aqueous back extraction solution containing 0.025 mol/L of DPA and 0.4 mol/L of HNO₃;

(3) 1.0 mL of the above plutonium-containing waste organic phase was added to a 15 mL polypropylene centrifuge tube, and then 1.0 mL of the above DPA-HNO₃ aqueous back extraction solution was added to the centrifuge tube, followed by shaking for 5 min at room temperature; and after centrifugation at 4000 r/min for 5 min, 10 µL of an organic phase was taken for liquid scintillation measurement, and a plutonium primary back extraction rate was calculated to be 97.1%.

Plutonium back extraction rate (%) = 1–plutonium content in the waste organic phase after elution/plutonium content in an initial wast organic phase × 100%.

(4) a lower aqueous phase in the step (3) was removed, and 1.0 mL of a same concentration of DPA-HNO₃ solution was added to the organic phase again, followed by shaking for 5 min at room temperature; and after centrifugation, 10 µL of an organic phase was taken for liquid scintillation measurement, and a plutonium secondary back extraction rate was calculated to be 92.6% and a total back extraction rate was calculated to be 99.78%, as shown in Table 1.

### Example 2

This example adopted the same method as that in Example 1 except that the back extraction solution used in this example was a 0.025 mol/L DPA solution; and a plutonium back extraction rate is shown in Table 1.

### Example 3

This example adopted the same method as that in Example 1 except that the aqueous back extraction solution used in this example contained 0.025 mol/L of DPA and 0.2 mol/L of HNO₃; and a plutonium back extraction rate is shown in Table 1.

### Example 4

This example adopted the same method as that in Example 1 except that the aqueous back extraction solution used in this example contained 0.025 mol/L of DPA and 0.8 mol/L of HNO₃; and a plutonium back extraction rate is shown in Table 1.

### Example 5

This example adopted the same method as that in Example 1 except that the back extraction solution used in this example was a DPA-HNO₃ mixed solution containing 0.025 mol/L of DPA and 1.5 mol/L of HNO₃; and a plutonium back extraction rate is shown in Table 1.

### Example 6

This example adopted the same method as that in Example 1 except that the back extraction solution used in this example was a DPA-HNO₃ mixed solution containing 0.025 mol/L of DPA and 3.0 mol/L of HNO₃; and a plutonium back extraction rate is shown in Table 1.

TABLE 1

| Example | DPA concentration | HNO₃ concentration | Phase ratio (a:o) | Primary back extraction rate | Secondary back extraction rate | Total back extraction rate |
|---|---|---|---|---|---|---|
| 1 | 0.025 mol/L | 0.4 mol/L | 1:1 | 96.8% | 92.2% | 99.75% |
| 2 | 0.025 mol/L | 0 mol/L | 1:1 | 97.3% | 92.2% | 99.79% |
| 3 | 0.025 mol/L | 0.2 mol/L | 1:1 | 97.1% | 92.6% | 99.78% |
| 4 | 0.025 mol/L | 0.8 mol/L | 1:1 | 97.4% | 90% | 99.74% |
| 5 | 0.025 mol/L | 1.5 mol/L | 1:1 | 95.4% | 91.2% | 99.59% |
| 6 | 0.025 mol/L | 3.0 mol/L | 1:1 | 95.7% | 86.2% | 99.4% |

It can be seen from the results in Table 1 that when a phase ratio of the waste organic phase to the aqueous back extraction solution was 1:1, the DPA concentration was 0.025 mol/L, the HNO₃ concentration was increased from 0 mol/L to 3.0 mol/L, the primary back extraction rate was 95% or above, and the secondary back extraction rate was 86% or above, the use of DPA as a back extraction agent can effectively perform back extraction on retained plutonium in the waste organic phase, and after nitric acid was added, although an acidity had a slight inhibitory effect on the plutonium back extraction rate, back extraction can be effectively performed on plutonium in the 0-3.0 mol/L HNO₃ solution.

### Example 7

This example adopted the same treatment method as that in Example 1 except that the number of back extractions was 5, and a back extraction rate is as shown in Table 2.

### Example 8

This example adopted the same treatment method as that in Example 1 except that the phase ratio of the aqueous back extraction solution to the waste organic phase was 1:5, and the number of back extractions was 5, and a back extraction rate is as shown in Table 2.

### Example 9

This example adopted the same treatment method as that in Example 1 except that the phase ratio of the aqueous back extraction solution to the waste organic phase was 1:10, and the number of back extractions was 5; and a back extraction rate is as shown in Table 2.

TABLE 2

| Example | Phase ratio (a:o) | Primary back extraction rate | Secondary back extraction rate | Third back extraction rate | Fourth back extraction rate | Fifth back extraction rate | Total back extraction rate |
|---|---|---|---|---|---|---|---|
| 7 | 1:1 | 99.87% | 50.19% | 57.04% | 25.04% | 10.35% | 99.98% |
| 8 | 1:5 | 94.7% | 67.6% | 65.0% | 52.1% | 50.3% | 99.86% |
| 9 | 1:10 | 93.7% | 68.1% | 66.5% | 53.1% | 48.9% | 99.84% |

It can be seen from Table 2 that DPA was used as a complexing agent to effectively perform back extraction on retained plutonium in the waste organic phase of the post-treatment process in an acidic solution. Even when the phase ratio of the organic phase to the aqueous phase was 10:1, a plutonium single-stage back extraction rate can reach 90% or above, and if the DPA concentration, the reaction temperature, and the acidity of the aqueous phase were further optimized or multi-stage back extraction was adopted, the plutonium single-stage back extraction rate of plutonium can reach 99.9% under the condition of the phase ratio of the organic phase to the aqueous phase being 10:1.

### Example 10

A 2BW feed solution obtained from a certain thermal test in a post-treatment process research of China Institute of Atomic Energy was used as a treatment subject; the feed solution was a dirty solvent with the plutonium content exceeding the standard obtained from a plutonium purification cycle, and was subjected to excessive plutonium back extraction by using a dilute acid solution, a tetravalent uranium solution, a N,N-dimethylhydroxylamine solution and a sodium carbonate solution, respectively in the test process; its main chemical components were as follows: 30% by volume of tributyl phosphate (TBP) and 70% by volume of hydrogenated kerosene, with a plutonium content of 0.057 g/L, a nitric acid content of 0.03 mol/L, a dibutyl phosphate (DBP) content of 0.9 mmol/L, and a monobutyl phosphate (MBP) content of 2.30× 10⁻ ⁴ mol/L, a trace amount of tetravalent uranium was negligible, and the contents of other degradation products and metal ions were not determined. Prior to this test, the feed solution had been placed for more than 5 years and its appearance was a yellow-brown clear solution.

A recycling process was as follows:

(1) a jacketed ion exchange column was connected to an inlet and outlet water pipe of a water bath, the temperature of the water bath was controlled to be 60° C., and 100-200-mesh DOWEX 1×4 was selected as an anion exchange resin. The resin was soaked in deionized water for 24 hours, followed by loading onto the column with a column volume of 1 mL. The resin was transformed with 10 mL of a 1 M HNO₃ solution, and after transformation was completed, deionized water was allowed to pass through the column until an eluate was neutral.

(2) A 0.025 mol/L DPA solution was used as an aqueous back extraction agent, the aqueous back extraction product after the first back extraction was used as a solution that was loaded onto a column, 10 µL of the solution that was loaded onto the column was taken to measure a count under 0-21 kev to be 3631225, 0.3 mL of the solution that was loaded onto the column was added to the anion exchange column, and elution was performed with 5 mL of the 0.025 mol/L DPA solution. 1 mL of an eluate was collected each time, and 10 µL of the eluate was respectively taken to measure a counting rate under 0-21 kev.

(3) Pu (IV) was desorbed with a 1 M HNO₃ solution at a constant temperature of 60° C., 1 mL of the 1 M HNO₃ solution was added each time, and eluates were collected. 1 mL of the first 15 eluate samples were collected each time, numbered desorption No. 1-15; 5 mL of an eluate was then collected each time, numbered desorption No. 16, 21, 26, and 31, respectively. 10 µL of the sample was respectively taken to measure a liquid scintillation counting rate.

(4) Finally, Pu (IV) was continued to be desorbed with 10 mL of an eluent containing 0.5 M HNO₃ and 0.1 M NH₂OH, an eluate was collected, and 10 µL of the sample was taken to measure a liquid scintillation counting rate.

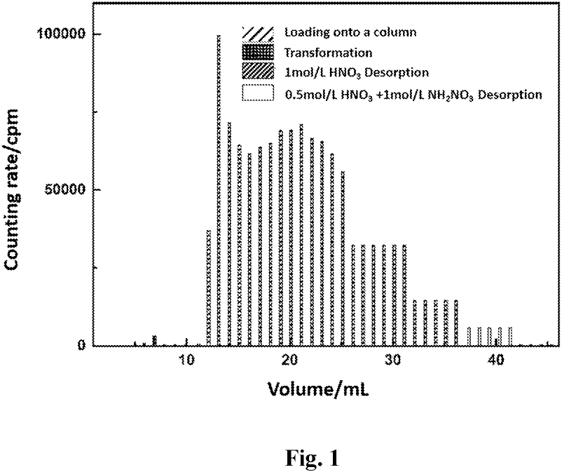

(5) A counting rate change curve at different stages after a plutonium back extraction solution was loaded onto a column is shown in FIG. 1. It can be seen that in the stage of loading onto the column, the counting rate in the eluate was as low as background, and was negligible; a very small amount of plutonium flowed through the first two column volumes of a transformation stage, which was caused by the insufficient concentration of nitric acid in the process of increasing the concentration of nitric acid in the exchange column to 7.5 mol/L, and the eluate was adjusted to 7.5 mol/L HNO₃ and reloaded onto the column, which can solve the problem; a plutonium counting rate in a stage of desorption with an eluent containing 1 M HNO₃ and in a stage of desorption with an eluent containing 0.5 M HNO₃ and 0.1 M NH₂OH was 99.5% of a total counting rate, indicating that 99% or above of plutonium in the back extraction solution was efficiently recovered by using this method.

### Comparative Example 1

1.0 mL of the plutonium-containing waste organic phase with the residual acid removed was added to a 15 mL polypropylene centrifuge tube, and 1.0 mL of a 0.5 mol/L sodium carbonate solution was then added to the centrifuge tube, followed by shaking for 5 min at room temperature; and after centrifugation at 4000 r/min for 5 min, it was found that three phases appeared in the centrifuge tube, a white emulsion between the upper organic phase and the lower aqueous phase caused the two phases to be difficult to separate.

It can be seen from the results of the above examples and the above comparative example that the method for treating retained plutonium in the waste organic phase of the PUREX process provided by the disclosure can efficiently elute a high content of retained plutonium in the waste organic phase, even a waste organic phase with high retained plutonium content that was placed for a long time, and 99% or above of plutonium can be recovered after loading onto the column for adsorption-transformation-desorption by using the anion exchange column; and this method has good application prospects in the elution and recovery of retained plutonium in the waste organic phase with high retained plutonium content of the spent fuel post-treatment process.

The preferred examples of the disclosure have been described above in detail with reference to the accompanying drawings, but the disclosure is not limited to specific details in the above examples, and many simple modifications may be made to the technical solutions of the disclosure within the technical idea of the disclosure, and these simple modifications are within the scope of protection of the disclosure.

In addition, it should be noted that various specific technical features described in the above detailed description may be combined in any suitable manner without contradiction, and in order to avoid unnecessary repetition, the disclosure is not otherwise described with respect to the various possible combinations.

In addition, any combination between the various different examples of the disclosure may also be made, and should likewise be regarded as the contents disclosed by the disclosure as long as it does not depart from the idea of the disclosure.

What is claimed is:

1. A method for treating retained plutonium in a waste organic phase of a plutonium uranium reduction extraction (PUREX) process, the waste organic phase of the PUREX process containing an organic solvent and plutonium, wherein the method comprises contacting the waste organic phase of the PUREX process with an aqueous back extraction solution containing 2,6-pyridinedicarboxylic acid for back extraction to obtain a back extraction product.

2. The method according to claim 1, wherein a weight ratio of the aqueous back extraction solution containing 2,6-pyridinedicarboxylic acid to the waste organic phase is 1:(1-10); and
the content of 2,6-pyridinedicarboxylic acid in the aqueous back extraction solution is 0.1-0.7 wt%.

3. The method according to claim 2, wherein the weight ratio of the aqueous back extraction solution containing 2,6-pyridinedicarboxylic acid to the waste organic phase is 1:(1-5);
the content of 2,6-pyridinedicarboxylic acid in the aqueous back extraction solution is 0.3-0.5 wt%.

4. The method according to claim 1, wherein the back extraction is performed at a temperature of 10-40° C. at an oscillation rate of 400-700 rpm for 10-30 min.

5. The method according to claim 4, wherein the back extraction is performed at a temperature of 20-30° C. at an oscillation rate of 500-600 rpm for 15-20 min.

6. The method according to claim 1, wherein the method further comprises:
S1, contacting the back extraction product with an anion exchange resin such that plutonium in the back extraction product is adsorbed on the anion exchange resin to obtain an anion exchange resin adsorbing plutonium;
S2, contacting the anion exchange resin adsorbing plutonium with a transformation liquid to obtain a transformed anion exchange resin adsorbing plutonium; and
S3, contacting the transformed anion exchange resin adsorbing plutonium with an eluent to obtain an elution product.

7. The method according to claim 6, wherein the step S1 further comprises contacting the back extraction product with the anion exchange resin after a pH of the back extraction product is adjusted to be 1-4.

8. The method according to claim 6, wherein the transformation liquid contains 7-8 mol/L of nitric acid; and
the eluent comprises 0.3-1.0 mol/L of an aqueous nitric acid solution, or the eluent is an aqueous solution containing 0.3-1.0 mol/L of nitric acid and 0.05-0.15 mol/L of NH₂OH.

9. The method according to claim 6, wherein the anion exchange resin comprises at least one of DOWEX resin, D201 resin and Diaion PA308 resin, preferably DOWEX 1x4 anion exchange resin.

10. The method according to claim 1, wherein the method further comprises contacting the waste organic phase of the PUREX process with deionized water and/or an alkaline solution for deacidification prior to contacting the waste organic phase of the PUREX process with the aqueous back extraction solution containing 2,6-pyridinedicarboxylic acid.
